(19) United States
(12) Patent Application Publication
(10) Pub. No.: US 2004/0183657 A1
(43) Pub. Date: Sep. 23, 2004

(54) Robbed vehicle information communication system for vehicle drivers

(76) Inventor: Eung-Soon Chang, Seoul (KR)

Correspondence Address: R. Neil Sudol, 714 Colorado Avenue, Bridgeport, CT, 06605-1601, US

(21) Appl. No.: 10/391,474

(22) Filed: Mar. 18, 2003

(51) Int. Cl. B60R 25/10

(52) U.S. Cl. 340/426.13

(57) ABSTRACT

The present invention relates to a robbed vehicle information communication system for vehicle drivers which includes a remote control transmission unit which outputs a password and a work code, a remote control receiving unit which receives a password and work code outputted from the remote control transmission unit and operates a door key switch and a power control switch, a vehicle robbed information transmission unit which is connected with the door key switch and the start key switch, respectively, and transmits his vehicle robbed information to other vehicle drivers nearby, and a vehicle robbed information receiving unit which receives a vehicle robbed information from the other vehicles nearby, wherein in the remote control transmission unit, the remote control receiving unit which is carried by a vehicle driver, and the vehicle robbed information transmission unit and the vehicle robbed information receiving are integrally formed.

### BACKGROUND OF THE INVENTION

1. Field of the Invention

The present invention relates to a robbed vehicle information communication system for vehicle drivers, and in particular to a robbed vehicle information communication system for vehicle drivers which is capable of transmitting and receiving an information of a robbed vehicle between vehicle drivers.

2. Description of the Background Art

In a conventional art, there are various robbed vehicle information communication systems such as a GPS, mobile communication GPS, radio signal GPS, etc. However, the above described systems are installed in a robbed vehicle, so that it is possible to receive and confirm an information and position of a robbed vehicle at a certain signal receiving place such as a control center, patrol vehicle or check point by communicating with a terminal installed in a robbed vehicle.

Therefore, there are some problems that it is impossible to transmit and receive a vehicle robbed information of a vehicle to other vehicle drivers, it is impossible to receive a vehicle robbed information of other's vehicles, and a common vehicle driver can not judge whether there are robbed vehicles nearby. Therefore, it is impossible to implement a robbed vehicle information communication between vehicle drivers and a robbed vehicle information communication between a common vehicle driver and a police patrol car because it is impossible to report the robbed vehicle to a policeman due to the above problems.

### SUMMARY OF THE INVENTION

Accordingly, it is an object of the present invention to provide a robbed vehicle information communication system for vehicle drivers which overcomes the problems encountered in the conventional art.

It is another object of the present invention to provide a robbed vehicle information communication system for vehicle drivers which is capable of transmitting and receiving a vehicle robbed information between vehicle drivers to other vehicle drivers, receiving a vehicle robed information of the other's vehicle, and judging whether there is a robbed vehicle nearby.

It is further object of the present invention to provide a robbed vehicle information communication system for vehicle drivers which is capable of implementing a network which operates as a robbed vehicle search police patrol car base station between vehicles on a street without separately operating a conventional trace vehicle, base station, control center, check point, etc. which need a high expenses.

It is still further object of the present invention to provide a robbed vehicle information communication system for vehicle drivers which is capable of implementing a robbed vehicle information communication between vehicle drivers and a robbed vehicle information communication between a common citizen driver and a policeman in such a manner that a position and running direction of a robbed vehicle are reported to a vehicle owner, police station or traffic broadcasting station between common vehicle drivers.

To achieve the above objects, in a vehicle robbed information communication system for vehicle drivers installed in a vehicle, there is provided a vehicle robbed information communication system for vehicle drivers which includes:

a remote control transmission unit which outputs a password and a work code;

a remote control receiving unit which receives a password and work code outputted from the remote control transmission unit and operates a door key switch and a power control switch;

a vehicle robbed information transmission unit which is connected with the door key switch and the start key switch, respectively, and transmits his vehicle robbed information to other vehicle drivers nearby; and

a vehicle robbed information receiving unit which receives a vehicle robbed information from the other vehicles nearby,

wherein in the remote control transmission unit, the remote control receiving unit which is carried by a vehicle driver, and the vehicle robbed information transmission unit and the vehicle robbed information receiving are integrally formed.

### BRIEF DESCRIPTION OF THE DRAWINGS

The present invention will become better understood with reference to the accompanying drawings which are given only by way of illustration and thus are not limitative of the present invention, wherein;

FIG. 1 is a block diagram illustrating a robbed vehicle information communication system for vehicle drivers according to a preferred embodiment of the present invention; and

FIG. 2 is a flow chart of a robbed vehicle information communication system for vehicle drivers according to a preferred embodiment of the present invention.

<Descriptions of reference numerals
of major elements of the drawing>

| | |
|---|---|
| 1: remote controller transmission | 2: remote controller receiving Unit |
| unit | |
| 3: robbed information | 4: robbed information receiving unit |
| transmission unit | |
| 5: switch unit | 6, 17: microcomputer |
| 7, 12, 23, 26: high frequency | 8, 22: modulator |
| oscillator | |
| 9, 11: antenna | 10: battery |
| 13, 25: receiving and tuning unit | 14, 27: amplification unit |
| 15, 28: wave detection unit | 16: direct current amplification unit |
| 18: door key switch | 19: start key switch |
| 20: microphone | 21: memory |
| 24: high frequency amplification | 29: low frequency amplification unit |
| unit | |
| 30: speaker | 31: power control switch |
| 32: vehicle battery | |

### DETAILED DESCRIPTION OF THE PREFERRED EMBODIMENTS

The preferred embodiments of the present invention will be described with reference to the accompanying drawings.

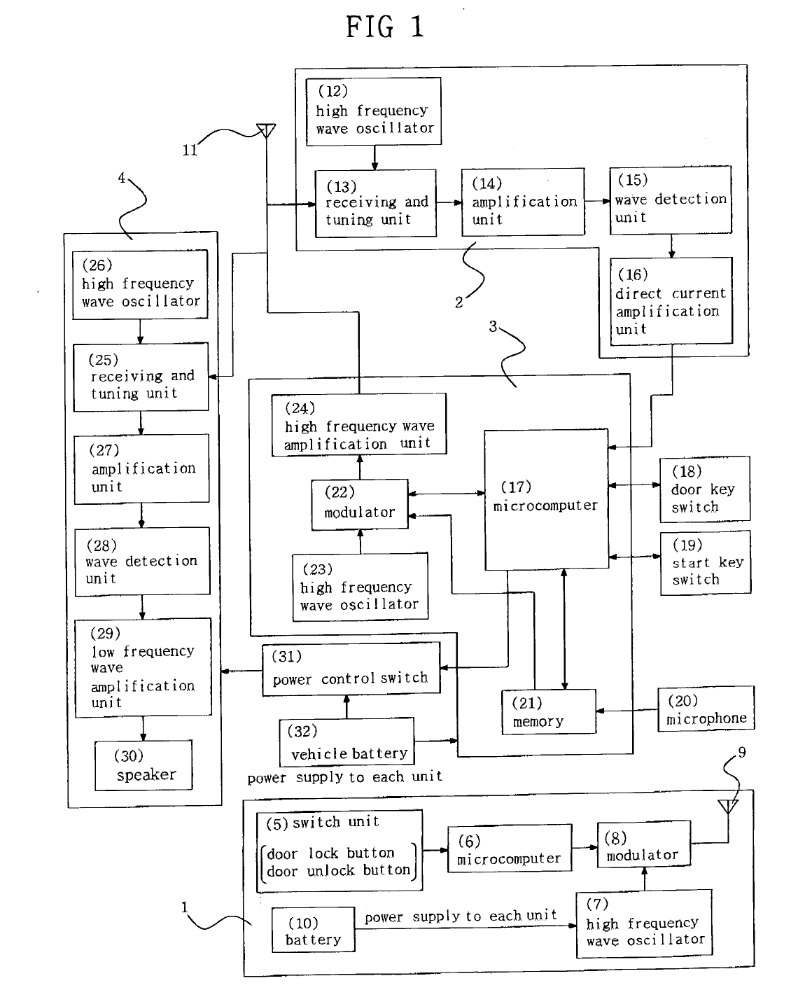

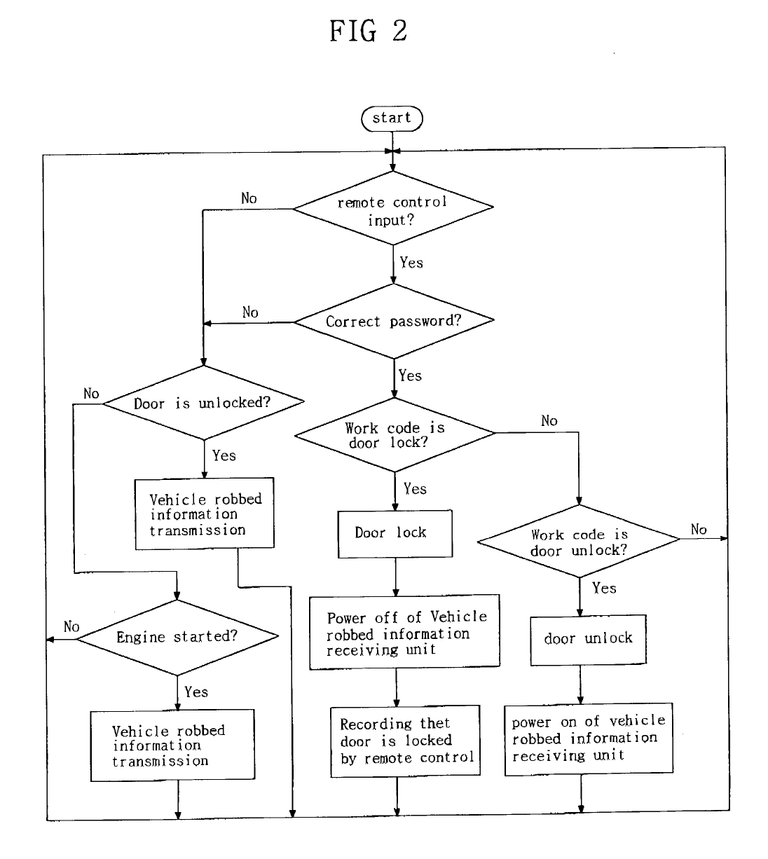

FIG. 1 is a block diagram illustrating a robbed vehicle information communication system for vehicle drivers according to a preferred embodiment of the present invention, and FIG. 2 is a flow chart of a robbed vehicle information communication system for vehicle drivers according to a preferred embodiment of the present invention. As shown therein, there are provided a remote controller transmission and receiving unit 1, a remote controller receiving unit 2, a robbery information transmission unit 3, a robbery information receiving unit 4, a switch unit 5, a microcomputer unit(MICOM) 6, 17, a high frequency oscillator 7, 12, 23, 26, a modulator 8, 22, an antenna 9, 11, a battery 10, a receiving and tuning unit 13, 25, an amplification unit 14, 27, a wave detection unit 15, 28, a direct current amplification unit 16, a door key switch 18, a start key switch 19, a microphone 20, a memory 21, a high frequency amplification unit 24, a low frequency wave amplification unit 29, a speaker 30, a power control switch 31, and a vehicle battery 32.

The construction and operation of the present invention will be described with reference to FIGS. 1 and 2. In the construction of the present invention, the remote controller transmission unit 1 outputs a password and work code. The remote controller receiving unit 2 receives a password and work code from the remote control transmission unit 1 and operates the door key switch 18 and the power control switch 31. The robbery information transmission unit 3 is connected with the door key switch 18 and the start key switch 19 and transmits a vehicle robbed information to other vehicle drivers nearby. The robbery information receiving unit 4 receives a vehicle robbed information from the other vehicle nearby. The remote control receiving unit 4 is carried by a vehicle driver. The remote control receiving unit 2, the vehicle robbed information transmission unit 3, and the vehicle robbed information receiving unit 4 are integrally constituted and are connected with the vehicle battery and are installed in the vehicle, so that it is possible to transmit and receive the information concerning the kinds, color, license number, position and running direction of the robbed vehicle between the vehicle drivers nearby.

The remote control transmission unit 1 is constituted in such a manner that when a button of the switch unit 5 is pressed, the power of the battery 10 is applied to the microcomputer 6, and the password and work code previously programmed in the microcomputer 6 are transmitted through the modulator 8 having the high frequency wave oscillator 7 and the antenna 9. When the button of the door lock(LOCK) of the switch unit 5 of the remote control transmission unit 1 is pressed, the door lock work code and the password are transmitted in radio, and the transmitted radio is received and tuned through the antenna 11 of the remote control receiving unit 2 and the receiving and tuning unit 13 and the high frequency wave oscillator 12 and is amplified by the amplification unit 14 and is demodulated by the radio detection unit 15 and is amplified by the direct current amplification unit 16 and is applied to the microcomputer 17. The door key switch 18 is operated in accordance with a control of the microcomputer 17, so that the door of the vehicle is locked, After the door is locked, in a state that the correct password is not inputted through the remote control transmission unit 1, if the door is opened, or the engine is started, a previously stored robbery information, for example, “the vehicle is robbed, the robbed vehicle is grandeur, the vehicle license number is Seoul 33A-4567, the color is black, the position is within 150 m from your vehicle, if you hear this message more than two times, the running direction of the robbed vehicle is the same as yours, please check and report to the police, the compensation money will be given, the reporting telephone number is 611-1236”, will be continuously repeatedly outputted in accordance with a control of the microcomputer 17 of the vehicle robbed information transmission unit 3 connected with the door key switch 18 and the start key switch 19 and is high frequency-modulated by the modulator 22 having the high frequency wave oscillator and is amplified by the high frequency wave amplification unit 24 and is transmitted through the antenna 11. The transmitted vehicle robbed information is received and tuned through the antenna 11 of the robbed vehicle information receiving unit 4 installed in the other's vehicles nearby and the receiving and tuning unit 25 and the high frequency wave oscillator 26 and is amplified by the amplification unit 27 and is demodulated by the wave detection unit 28 for thereby obtaining an audio information. The thusly obtained audio information is amplified by the low frequency wave amplification unit 29 and the outputted through the speaker 30.

In addition, the vehicle robbed information transmission unit 3 is always connected with the power of the vehicle battery for thereby transmitting a vehicle robbed information. When a vehicle owner who finished a driving operation locks a vehicle door by pressing a door lock button of the switch unit 5 of the remote control transmission unit 1, the power control switch 31 is turned off in accordance with a control of the microcomputer 17 of the remote control receiving unit 2 for thereby disconnecting the power of the vehicle robbed information receiving unit 4 for thereby preventing a vehicle robber from hearing a vehicle robbed information when the vehicle robbed information is transmitted from the vehicle robbed information transmission unit 3. On the contrary, when the vehicle owner opens the vehicle door by pressing the door unlock button of the switch unit 5 of the remote control transmission unit 1, the power control switch 31 is turned on in accordance with a control of the microcomputer 17 of the remote control receiving unit 2, so that the power is supplied to the vehicle robbed information receiving unit 4 for thereby receiving a vehicle robbed information from other vehicles.

In addition, a transmission electric power for outputting a vehicle robbed information is about 0.5 w for thereby limiting the radius of a signal transmission and receiving range to 150 m which is a short distance, so that the vehicle drivers can accurately recognize the vehicle robbed information in an effective range.

Even when the radius of the signal transmission and receiving range is short like within 150 m, a communication zone is continuously formed in proportion to the distance that the robbed vehicle runs. In an advanced country in which a traffic is so complicated, since the vehicles run at a high frequency, about only 1% of the total numbers of the vehicles of the country adapts the present invention, it is possible to accurately receive the vehicle robbed information between the vehicle drivers and check the current position of the robbed vehicle within 1 through 10 minutes after the vehicle is robbed.

As described above, in the present invention, it is possible to transmit his robbed vehicle information between common vehicle drivers to other vehicle drivers. In addition, it is possible to receive a vehicle robbed information of other vehicle drivers and to judge the robbed vehicle nearby by vehicle drivers.

In addition, in the present invention, it is possible to form a network which operates as a robbed vehicle check patrol base station between the vehicles on the street without separately operating the conventional trace vehicle, base station, control center, and check point which require a high cost.

Furthermore, in the present invention, it is possible to implement a robbed vehicle information communication between vehicle drivers and a robbed vehicle information communication between a common citizen driver and a policeman in such a manner that a position and running direction of a robbed vehicle are reported to a vehicle owner, police station or traffic broadcasting station between common vehicle drivers.

As the present invention may be embodied in several forms without departing from the spirit or essential characteristics thereof, it should also be understood that the above-described examples are not limited by any of the details of the foregoing description, unless otherwise specified, but rather should be construed broadly within its spirit and scope as defined in the appended claims, and therefore all changes and modifications that fall within the meets and bounds of the claims, or equivalences of such meets and bounds are therefore intended to be embraced by the appended claims.

What is claimed is:

1. A robbed vehicle information communication system for inter-drivers, comprising:
a remote control transmission unit which outputs a password and a work code;
a remote control receiving unit which receives a password and a work code outputted from the said remote control transmission unit and operates a door key switch and a power control switch;
a robbed vehicle information transmission unit which is connected with the door key switch and the start key switch, respectively, and transmits his robbed vehicle information to other nearby drivers; and
a robbed vehicle information receiving unit which receives a robbed vehicle information transmitted from the other nearby vehicles,
wherein the remote control receiving unit carried by a vehicle driver, and the remote control receiving unit, the robbed vehicle information transmission unit and the vehicle robbed information receiving are integrally formed.

2. The system of claim 1, wherein the said remote control transmission unit is constituted in such a manner that when a button of the switch unit is pressed, the power of the battery is applied to the microcomputer, and the password and the work code predetermined programmed in the microcomputer are transmitted through the modulator having the high frequency wave oscillator and the antenna, and when the button of the door lock of the switch unit of the remote control transmission unit is pressed, the door lock work code and the password are transmitted in radio, and the transmitted radio is received and tuned through the antenna of the remote control receiving unit and the receiving and tuning unit and the high frequency wave oscillator and is amplified by the amplification unit and is demodulated by the radio detection unit and is amplified by the direct current amplification unit and is applied to the microcomputer, and the door key switch is operated in accordance with a control of the microcomputer, so that the door of the vehicle is locked, and in a state that the correct password is not inputted through the remote control transmission unit, if the door is opened, or the engine is started, a previously stored robbery information is continuously repeatedly outputted in accordance with a control of the microcomputer of the robbed vehicle information transmission unit connected with the door key switch and the start key switch and is high frequency-modulated by the modulator having the high frequency wave oscillator and is amplified by the high frequency wave amplification unit and is transmitted through the antenna, and the transmitted robbed vehicle information is received and tuned through the antenna of the robbed vehicle information receiving unit installed in the other's vehicles nearby and the receiving and tuning unit and the high frequency wave oscillator and is amplified by the amplification unit and is demodulated by the wave detection unit for thereby obtaining an audio information, and the thusly obtained audio information is amplified by the low frequency wave amplification unit and the outputted through the speaker.

3. The system of either claim 1 or claim 2, wherein the said robbed vehicle information transmission unit is always connected with the power of the vehicle battery for thereby transmitting a robbed vehicle information, and when a vehicle owner who finished a driving operation locks a vehicle door by pressing a door lock button of the switch unit of the remote control transmission unit, the power control switch is turned off in accordance with a control of the microcomputer of the remote control receiving unit for thereby disconnecting the power of the robbed vehicle information receiving unit for thereby preventing a vehicle robber from hearing a robbed vehicle information when the vehicle robbed information is transmitted from the robbed vehicle information transmission unit, and when the vehicle owner opens the vehicle door by pressing the door unlock button of the switch unit of the remote control transmission unit, the power control switch is turned on in accordance with a control of the microcomputer of the remote control receiving unit, so that the power is supplied to the robbed vehicle information receiving unit for thereby receiving a robbed vehicle information from other vehicles.
